(19) United States
(12) Patent Application Publication
(10) Pub. No.: US 2008/0233976 A1
(43) Pub. Date: Sep. 25, 2008

(54) Method and Arrangement For Avoiding Colisions Between Access Attempts In a Mobile Communication Network

(75) Inventors: Peter Ostrup, Linkoping (SE); Lars-Goran Lund, Bromma (SE); Jens Bergqvist, Linkoping (SE)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), STOCKHOLM (SE)

(21) Appl. No.: 12/063,887

(22) PCT Filed: Aug. 23, 2005
(86) PCT No.: PCT/SE2005/001239

§ 371 Date: Feb. 15, 2008

(51) Int. Cl. H04Q 7/20

(52) U.S. Cl. 455/458

(57) ABSTRACT

A method and an arrangement for avoiding collision between first access attempts of at least two mobile stations being paged in a cell of a mobile communication network, wherein a paging message in a downlink channel comprises a pre-determined access order for the mobile stations being paged, whereby a first access attempt in a pre-determined TDMA frame in an uplink channel according to said access order is sent from the mobile stations being paged.

### TECHNICAL FIELD

The present invention relates to the field of mobile communication networks and, particularly, to an arrangement allowing for avoiding collision between first access attempts of at least two mobile stations being paged in a cell of a mobile communication network as well as a method for such avoidance.

### BACKGROUND OF THE INVENTION

The Global System for Mobile Communication (GSM) is one of the most widely deployed communication standards for mobile wireless communication. In GSM Time Division Multiple Access (TDMA) is used, where each frequency band is split into time slots, preferably eight and together these time slots make one TDMA frame. As an extension of GSM in order to introduce packet-switched technology, General Packet Radio Service (GPRS) was developed by the European Telecommunications Standards Institute (ETSI). One limitation of GPRS is that it does not support voice services. Therefore, the Third Generation Partnership Project (3GPP) has developed a new standard for GSM to support high rate data services. This standard is known as Enhanced Data Rates for Global Evolution (EDGE). One objective of EDGE is to provide voice services over the packet-switched network. In connection with the development of EDGE and other technologies for supporting higher data rates, a number of techniques for multiplexing different users on the same set of resources have been developed, such as the packet-switched mode of EDGE technology, the Enhanced GPRS (EGPRS).

A network according to these standards comprises a core network (CN), radio access networks (RAN) and mobile stations (MS) attached to a RAN, such as the GSM/EDGE Radio Access Network (GERAN) architecture or the UMTS Terrestrial Radio Access Network (UTRAN) architecture.

In the existing GERAN specifications, 3GPP TS 44.060 “Radio Link Control/Medium Access Control (RLC/MAC) protocol” describing the packet access procedure on the Packet Common Control Channel (PCCCH), it is stated that the mobile station shall send its first (EGPRS) PACKET CHANNEL REQUEST message in the first available Packet Random Access Channel (PRACH) block once the packet access procedure has been initiated. The mobile station shall then choose one of the four TDMA frames within that PRACH block randomly with a uniform probability distribution.

In order to decrease the access time, for the first ping, when the Common Control Channel (CCCH) is used in a cell of the mobile communication network, it has also been proposed in the GERAN standardisation, 3GPP TS 44.018 “Radio Resource Control (RRC) protocol”, to update the specifications describing the access procedure on the CCCH. The proposal, as discussed in 3GPP “GSM/EDGE Continued Evolution”, is to remove the existing delay of a random number of slots belonging to the mobile stations Random Access Channel (RACH) which means that the mobile stations do not have to wait before they can send their first access message (CHANNEL REQUEST or EGPRS PACKET CHANNEL REQUEST) on the RACH. In order to be able to handle the mobile terminated case on the CCCH, there will also be a need to spread the first accesses from the, up to four, paged mobile stations that are addressed in the same paging message.

One problem with removing the random access delay in the mobile terminated case, i.e. when the mobile station sends the CHANNEL REQUEST or EGPRS PACKET CHANNEL REQUEST message, is that there is a risk for collisions if there are several mobile stations being paged in the same paging message. Up to four different mobile stations can be paged in one paging message and there is a high probability that they all will try to access the same RACH slot leading to collisions, according to the existing procedure on the CCCH.

When several mobile stations are being paged in one paging message on the PCCCH and send their PACKET CHANNEL REQUEST or EGPRS PACKET CHANNEL REQUEST message on the PRACH, all these mobile stations would perform their first access attempt in the same PRACH block with, according to the existing procedure on the PCCCH, a random distribution between the four TDMA frames within that block. The risk that one of these first access attempts collide with another access attempt is then at least (since there might be other access attempts than those from the paged mobile stations):
25% in case of two mobile stations in the cell being paged in the same paging message;
62.5% in case of three mobile stations in the cell being paged in the same paging message;
>90% in case of four mobile stations in the cell being paged in the same paging message;

There is, therefore, a need for an improved method and arrangement for first access attempts of mobile stations being paged in the same paging message in a mobile communication network, which overcome the problem of collision at these first access attempts.

### SUMMARY OF THE INVENTION

Accordingly, it is an objective of the present invention to provide an improved method for avoiding collision between first access attempts of at least two mobile stations being paged in a cell of a mobile communication network.

This objective is achieved through a method wherein each of said at least two mobile stations performs the steps of: receiving a paging message comprising a pre-determined access order from a downlink channel; and, sending a first access attempt in an uplink channel according to said access order.

Another objective with the present invention is to provide an improved arrangement for avoiding collision between first access attempts of at least two mobile stations being paged in a cell of a mobile communication network.

This other objective is achieved through providing an arrangement wherein each of said at least two mobile stations comprises: means for receiving a paging message comprising a pre-determined access order from a downlink channel; and, means for sending a first access attempt in an uplink channel according to said access order.

Thanks to the provision of a method and an arrangement which remove the risk of collisions between first access attempts of mobile stations being paged in the same paging message by specifying in what exact TDMA frame these mobile stations shall send their first access attempt, faster accesses and less load on the (P)RACH are obtained in comparison with the first access attempts according to the known prior art.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is an exemplary block diagram of a mobile communication network;

FIG. 2 is a flowchart showing the inventive method steps.

### DETAILED DESCRIPTION OF PREFERRED EMBODIMENTS

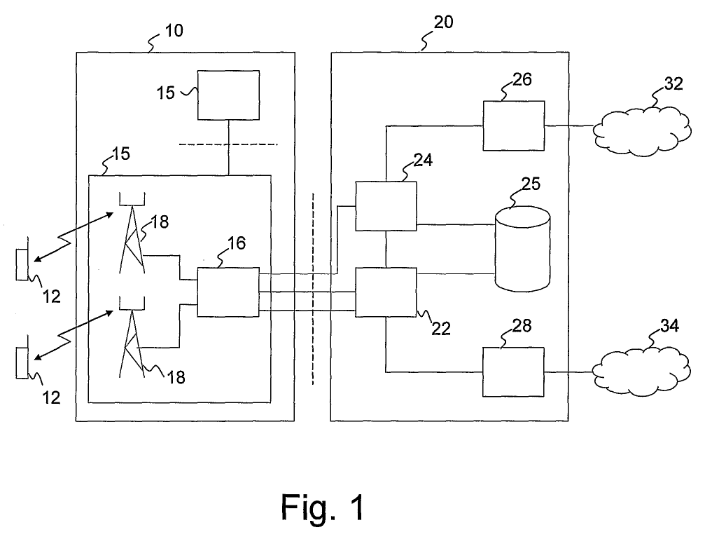

A block diagram of an exemplary 3GPP GSM system network is shown in FIG. 1. The network comprises a radio access network (RAN), which in the preferred embodiment of the present invention is a GSM/EDGE Radio Access Network (GERAN) 10 and a core network (CN) 20. The GERAN 10 and the CN 20 provide communication and control for a plurality of mobile stations (MS) 12.

The GERAN architecture 10 comprises a plurality of Base Station Systems (BSS) 15 each controlled by a Base Station Controller (BSC) 16 which is connected to a set of Base Transceiver Stations (BTS) 18. The BTSs 18 comprise the antennas, RF equipment and baseband processing circuits needed to communicate with the MSs 12. The BTSs 18 are connected to the BSC 16 through the Abis-interface.

The core network 20 typically comprises at least one Serving GPRS Support Node (SGSN) 22, one or more Gateway GPRS Support Node (GGSN) 28, at least one mobile switching center (MSC) 24, which may include a visitor location register (VLR) (not shown in FIG. 1), a Gateway MSC (GMSC) 26, and a GPRS home location register (HLR) 25. The CN 20 provides both circuit-switched and packet data communication with various external networks, typically including the Public Switched Telephone Network (PSTN) 32 and one or more packet mode communication network, such as the Internet 34. The GERAN 10 connects to the CN 20 through the A, Gb and Iu interfaces.

In the GPRS system the resources are the radio channels used for data transmission (PDCH, Packet Data Channel). Signalling used for general controlling takes place on a Common Control Channel (CCCH) or a Packet Common Control Channel (PCCCH) reserved for that purpose. The physical PDCH channels are divided into logical radio channels by means of a multiframe structure comprising continually transmitted 52 TDMA (Time Division Multiple Access) frames which are further divided into 12 blocks (Radio Block), each divided into 4 frames, and 4 idle frames. In downlink communication, these are used for data transmission and signalling, in uplink communication for data and signalling. In uplink communication, the Uplink State Flag (USF) value sent on the downlink channel is used to refer to these time slots, when e.g. a mobile station can transmit information.

Up to four MSs may be paged in one paging message on the CCCH or the PCCCH. The present invention specifies what exact TDMA frame the mobile stations that are paged in the paging message shall use in the concerned PRACH block or on the RACH. The risk of collision between the first access attempts of these mobile stations would then be removed.

In a preferred embodiment of the present invention the access order of the mobile stations being paged within a cell is based on the order the mobile station has in the list of addressed (paged) mobile stations in the paging message. The access order may be described as N+X, wherein N is a pre-determined number, such as e.g. 0, 1 or 8 (N may be any number suitable for the specific application), and X is the position of the paged mobile station in the list of paged mobile stations, thus:
the mobile station that is first in the list of paged mobile stations shall send its first access message (CHANNEL REQUEST, PACKET CHANNEL REQUEST or EGPRS PACKET CHANNEL REQUEST) in the N+1 TDMA frame in the next available PRACH block or on the RACH.
the mobile station that is second in the list of paged mobile stations shall send its first access message (CHANNEL REQUEST, PACKET CHANNEL REQUEST or EGPRS PACKET CHANNEL REQUEST) in the N+2 TDMA frame in the next available RACH slot or PRACH block;
the mobile station that is third in the list of paged mobile stations shall send its first access message (CHANNEL REQUEST, PACKET CHANNEL REQUEST or EGPRS PACKET CHANNEL REQUEST) in the N+3 TDMA frame in the next available RACH slot or PRACH block;
the mobile station that is fourth in the list of paged mobile stations shall send its first access message (CHANNEL REQUEST, PACKET CHANNEL REQUEST or EGPRS PACKET CHANNEL REQUEST) in the N+4 TDMA frame in the next available RACH slot or PRACH block.

The arrangement according to a preferred embodiment of the present invention for avoiding collision between first access attempts of at least two mobile stations being paged in a cell of a mobile communication network, thus comprises:
means for receiving in the paged mobile stations 12 a paging message comprising a pre-determined access order from a downlink channel, such as the Common Control Channel (CCCH) or the Packet Common Control Channel (PCCCH). The paging message comprises a list of paged mobile stations and the access order corresponds to the order of the paged mobile stations in the list. Optionally, a broadcast parameter provides the access order for the paged mobile stations; and,
means for sending a first access attempt in a pre-determined TDMA frame in an uplink channel, such as the Random Access Channel (RACH) or the Packet Random Access Channel (PRACH) according to said access order.

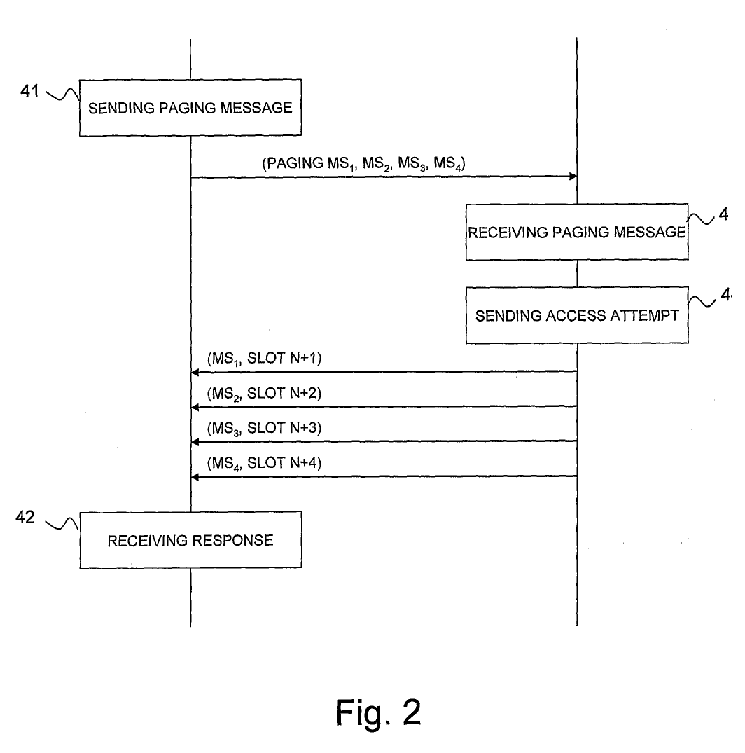

In a preferred embodiment of the present invention, the procedure in the mobile communication network for avoiding collision between first access attempts of at least two mobile stations being paged in a cell of the network, shown in FIG. 2 on the left hand side, is as follows:
sending a paging message on a downlink channel such as the CCCH or the PCCCH to the paged mobile stations (step 41). The paging message comprises a pre-determined access order, which in the preferred embodiment correspond to the order of the mobile stations in the list of paged mobile stations in the paging message as described above. Optionally, a broadcast parameter provides the access order for the paged mobile stations;
receiving a response from each paged mobile station in the pre-determined order on an uplink channel, such as the RACH or the PRACH (step 42).

In a preferred embodiment of the present invention, the procedure in the mobile stations for avoiding collision between first access attempts of at least two mobile stations being paged in a cell of a mobile communication network, shown in FIG. 2 on the right hand side, is as follows:
receiving a paging message on a downlink channel, such as the CCCH or the PCCCH from the network (step 43). The paging message comprises a pre-determined access order, which in the preferred embodiment correspond to the order of the mobile stations in the list of paged mobile stations in the paging message as described above. Optionally, a broadcast parameter provides the access order for the paged mobile stations;
sending a first access attempt according to the pre-determined order on an uplink channel, such as the RACH or the PRACH (step 44).

The preferred embodiment of the present invention concerns the TDMA technique, where each user is allocated a unique time slot for communication. The present invention may, however, be used in other types of techniques than time separation for separating users in a communication system, such as the Code Division Multiple Access (CDMA).

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method for avoiding collision between first access attempts of at least two mobile stations being paged in a cell of a mobile communication network, said method comprising the steps of:
each of said at least two mobile stations performs the steps of:
receiving a paging message comprising a pre-determined access order from a downlink channel; and,
sending a first access attempt in an uplink channel according to said access order.

2. The method according to claim 1, wherein said first access attempt is sent in a pre-determined TDMA frame in said uplink channel.

3. The method according to claim 1, wherein a list of paged mobile stations is provided in said paging message and said access order corresponds to the order of the paged mobile stations in said list.

4. The method according to claim 3, wherein said access order is slot N+X, wherein N is a pre-determined number and X is the position of the mobile station in said list.

5. The method according to claim 1, wherein said access order is provided in a broadcast parameter sent in said downlink channel.

6. A system for avoiding collision between first access attempts of at least two mobile stations being paged in a cell of a mobile communication network, wherein each of said at least two mobile stations comprises:
means for receiving a paging message comprising a pre-determined access order from a downlink channel; and,
means for sending a first access attempt in an uplink channel according to said access order.

7. The system according to claim 6, wherein said first access attempt is arranged to be sent in a pre-determined TDMA frame in said uplink channel.

8. The system according to claim 6, wherein said paging message comprises a list of paged mobile stations, wherein said access order is arranged to correspond to the order of the paged mobile stations in said list.

9. The system according to claim 8, wherein said access order is slot N+X, wherein N is a pre-determined number and X is the position of the mobile station in said list.

10. The system according to claim 6, wherein said downlink channel comprises a broadcast parameter providing said access order.

11. The system according to claim 6, wherein said downlink channel is a Common Control Channel (CCCH) and said uplink channel is a Random Access Channel (RACH).

12. The system according to claim 6, wherein said downlink channel is a Packet Common Control Channel (PCCCH) and said uplink channel is a Packet Random Access Channel (PRACH).

13. The system according to claim 6, wherein said mobile communication network is a General Packet Radio Service (GPRS) network.
